(19) United States
(12) Patent Application Publication
(10) Pub. No.: US 2016/0365742 A1
(43) Pub. Date: Dec. 15, 2016

(54) PORTABLE BACK-UP BATTERY PACK

(71) Applicants: David Baum, Orem, UT (US); KC Corbett, Orem, UT (US); Reed Quinn, Orem, UT (US); Chris Quinn, Orem, UT (US)

(72) Inventors: David Baum, Orem, UT (US); KC Corbett, Orem, UT (US); Reed Quinn, Orem, UT (US); Chris Quinn, Orem, UT (US)

(73) Assignee: FIBER FIX USA, LLC, Orem, UT (US)

(21) Appl. No.: 14/738,072

(22) Filed: Jun. 12, 2015

(51) Int. Cl. H02J 7/02

(52) U.S. Cl. CPC H02J 7/025; H02J 7/027

(57) ABSTRACT

A portable back-up battery pack. The portable back-up battery pack includes a housing and a rechargeable battery pack within the housing. The portable back-up battery pack also includes an electronic connector, where the electronic connector extends from the housing and is configured to create an electrical connection between the rechargeable battery pack and an external electronic device. The portable back-up battery pack further includes an attachment configured to connect the portable back-up battery pack to an external device.

### CROSS-REFERENCE TO RELATED APPLICATIONS

Not applicable.

### BACKGROUND OF THE INVENTION

Battery packs for cell phones are becoming increasingly common. As cell phones become a larger part of our everyday lives it becomes more necessary for people to have options for quickly charging a phone if something happens. However, many of these battery packs have the drawback of not being very portable. This is because they focus on fully charging the phone battery which means that the battery pack must be large to accommodate a larger battery. Increased size and weight means lower portability and increased inconvenience.

In addition, the battery packs often focus more on design considerations than on portability. Therefore, they often have empty spaces internally which don't add to the weight of the battery pack but the larger external size means that it is more difficult for a user to place the battery pack in a pocket, on a keychain or otherwise carry with them.

Accordingly, there is a need in the art for a battery pack that allows for portability. Further, there is a need in the art for a battery pack that minimizes internal space. Moreover, there is a need in the art for a battery pack that minimizes the total weight.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a portable back-up battery pack. The portable back-up battery pack includes a housing and a rechargeable battery pack within the housing. The portable back-up battery pack also includes an electronic connector, where the electronic connector extends from the housing and is configured to create an electrical connection between the rechargeable battery pack and an external electronic device. The portable back-up battery pack further includes an attachment configured to connect the portable back-up battery pack to an external device.

Another example embodiment includes a portable back-up battery pack. The portable back-up battery pack includes a housing that is approximately rectangular and a rechargeable battery pack within the housing. The portable back-up battery pack also includes a neck, where the neck includes a protrusion from the housing. The portable back-up battery pack further includes an electronic connector, where the electronic connector extends from the neck and is configured to create an electrical connection between the rechargeable battery pack and an external electronic device. The portable back-up battery pack additionally includes an attachment configured to connect the portable back-up battery pack to an external device.

Another example embodiment includes a portable back-up battery pack. The portable back-up battery pack includes a housing that is approximately rectangular and a rechargeable battery pack within the housing. The portable back-up battery pack also includes a neck, where the neck includes a protrusion from the housing. The portable back-up battery pack further includes an electronic connector, where the electronic connector extends from the neck and is configured to create an electrical connection between the rechargeable battery pack and an external electronic device. The portable back-up battery pack additionally includes a slider configured to extend and retract the electronic connector relative to the neck and an attachment configured to connect the portable back-up battery pack to an external device. The portable back-up battery pack moreover includes a charging port. The charging port is electrically connected to the rechargeable battery pack and is configured to allow a user to charge the rechargeable battery pack. The portable back-up battery pack also includes a charge indicator configured to allow a user to determine the charge level of the rechargeable battery pack.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a top view of the portable back-up battery pack;

FIG. 1B illustrates a front view of the portable back-up battery pack;

FIG. 1C illustrates a side view of the portable back-up battery pack;

FIG. 1D illustrates a perspective view of the portable back-up battery pack; and

FIG. 2 illustrates an example of an internal view of the portable back-up battery pack.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

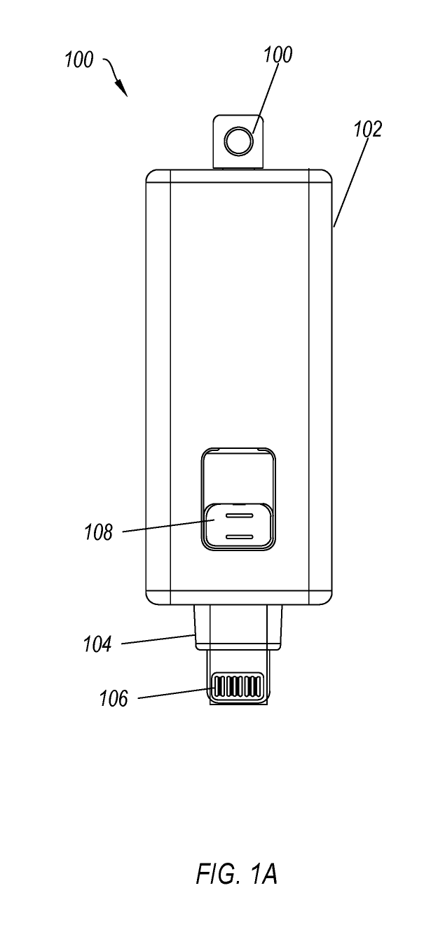

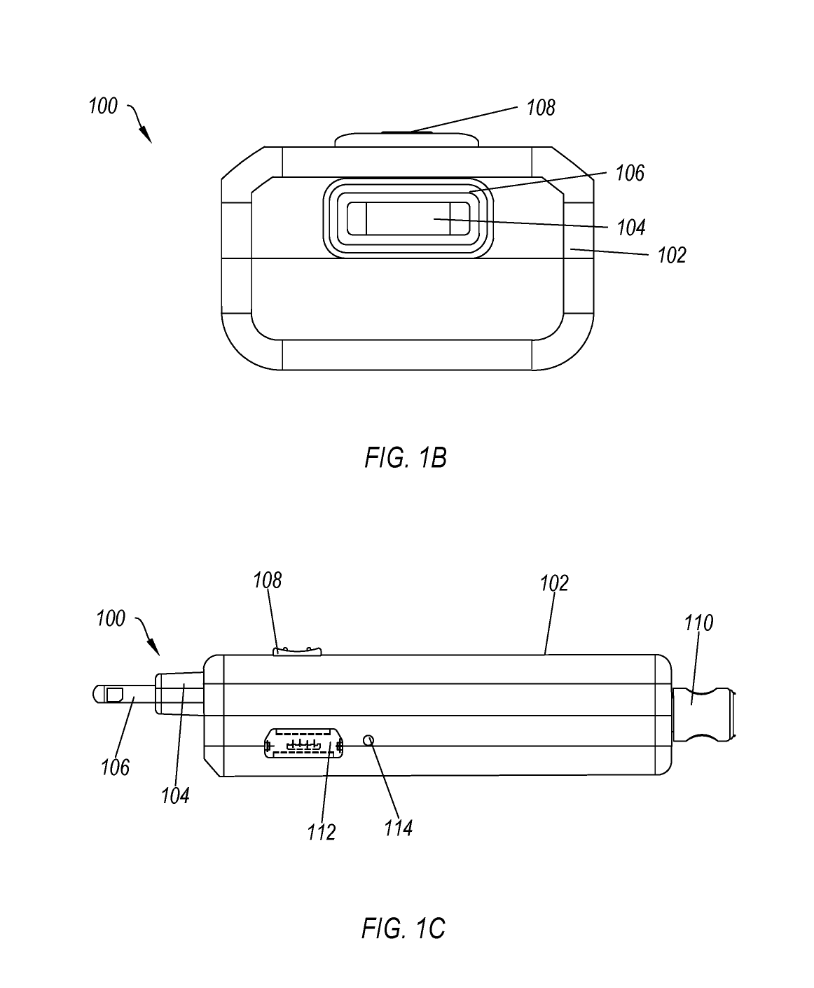

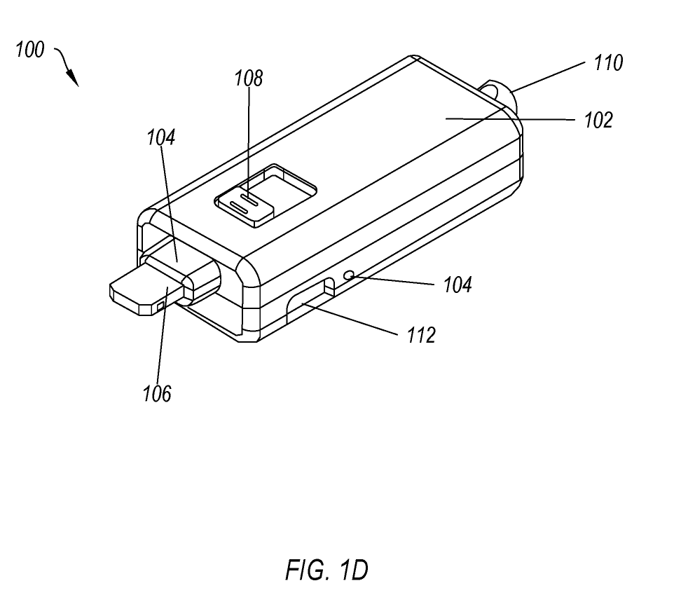

FIGS. 1A, 1B, 1C and 1D (collectively “FIG. 1”) illustrates a portable back-up battery pack 100 for an external electronic device. FIG. 1A illustrates a top view of the portable back-up battery pack 100; FIG. 1B illustrates a front view of the portable back-up battery pack 100; FIG. 1C illustrates a side view of the portable back-up battery pack 100; and FIG. 1D illustrates a perspective view of the portable back-up battery pack 100. The portable back-up battery pack 100 can be conveniently carried by a user to be used in the event that a full or partial charge of the electronic device becomes necessary. For example, the portable back-up battery pack 100 can be used to charge the battery of a cell phone, smart phone, tablet, laptop or other electronic device. The portable back-up battery pack 100 is small enough that it can be carried by a user during normal activity when not needed but carries enough charge to provide adequate supplemental power.

FIG. 1 shows that the portable back-up battery pack 100 can include a housing 102. The housing 102 can surround and protect the other elements of the portable back-up battery pack 100. In particular, the housing 102 can be configured to ensure that the other elements of the portable back-up battery pack 100 are in the proper position relative to one another. Further, the housing 102 can be configured to arrange the elements of the portable back-up battery pack 100 to ensure the smallest possible size, allowing for increased portability. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

For example, the housing 102 can be approximately rectangular (i.e., rectangular with rounded corners or edges) to minimize circumference based on internal volume required for internal components while simultaneously allowing for convenience of carrying and maximizing portability. That is, to allow for convenience of carrying and to allow for portability minimizing the circumference can be critical. For instance, the housing 102 can be between 10 mm and 15 mm tall (up and down as viewed in FIG. 1B). E.g., the housing 102 can be approximately 12.5 mm tall. Likewise, the housing can be between 16 mm and 26 mm wide (left to right as viewed in FIG. 1A) and between 38.5 mm and 58.5 mm long (up and down as viewed in FIG. 1A). For example, the housing can be approximately 21 mm wide and 48.5 mm long. These dimensions can be critical for allowing required internal components while maintaining the smallest possible volume. As used in the specification and the claims, the term approximately shall mean that the value is within 10% of the stated value, unless otherwise specified.

FIG. 1 also shows that the portable back-up battery pack 100 can include a neck 104. The neck 104 is a small protrusion that allows a phone to be charged even when a case is present on the device. For example, if the portable back-up battery pack 100 is used to charge a cell phone, the user does not have to remove the case on the phone because the neck 104 can be inserted through an opening in the case. That is, a case for an electronic device will normally allow access for a charging cord and the neck 104 can use the same access. In order to allow the neck 104 to be inserted through the case, the size of the neck can be critical. For example, the neck 104 can be between 3.5 mm and 5.5 mm tall (up and down as viewed in FIG. 1B). E.g., the neck 104 can be approximately 4.5 mm tall. Likewise, the housing can be between 7.8 mm and 11.8 mm wide (left to right as viewed in FIG. 1A) and between 4 mm and 6 mm long (up and down as viewed in FIG. 1A). For example, the housing can be approximately 9.8 mm wide and 5 mm long. These dimensions can be critical to ensure that the neck 104 passes through the case in the same manner as a charging cable.

FIG. 1 further shows that the portable back-up battery pack 100 can include an electronic connector 106. The electronic connector 106 creates an electrical connection between the portable back-up battery pack 100 and the connected device, allowing the portable back-up battery pack 100 to at least partially charge the connected device. That is the electronic connector 106 allows the portable back-up battery pack 100 to send power to the connected electronic device.

FIG. 1 additionally shows that the portable back-up battery pack 100 can include a slider 108. The slider 108 allows the electronic connector 106 to be either extended from or retracted into the neck 104. I.e., when not in use, the electronic connector 106 can be either partially or completely retracted into the neck 104, protecting it from damage. Conversely, when in use the electronic connector 106 can be extended from the neck 104 allowing for charging of the electronic device.

FIG. 1 moreover shows that the portable back-up battery pack 100 can include an attachment 110. The attachment 110 allows a user to connect the portable back-up battery pack 100 to an external device for convenience. For example, the attachment 110 can include a key chain attachment. Thus, the user can attach the portable back-up battery pack 100 to a key chain so that the portable back-up battery pack 100 can be used when needed.

FIG. 1 also shows that the portable back-up battery pack 100 can include a charging port 112. The charging port 112 can allow a user to charge the portable back-up battery pack 100 for future use. For example, the charging port 112 can receive a power cable. The cable can be connected to a power outlet or a USB cable (e.g., connected to a computer, power outlet or some other power source) or other charging mechanism.

FIG. 1 further shows that the portable back-up battery pack 100 can include a charge indicator 114. The charge indicator 112 can allow a user to determine the charge level of the portable back-up battery pack 100. For example, the charge indicator can include an LED which indicates a full charge, partial charge, or low charge. Additionally or alternatively, the charge indicator can include an app on the electronic device or connected computer which shows the user how much power remains.

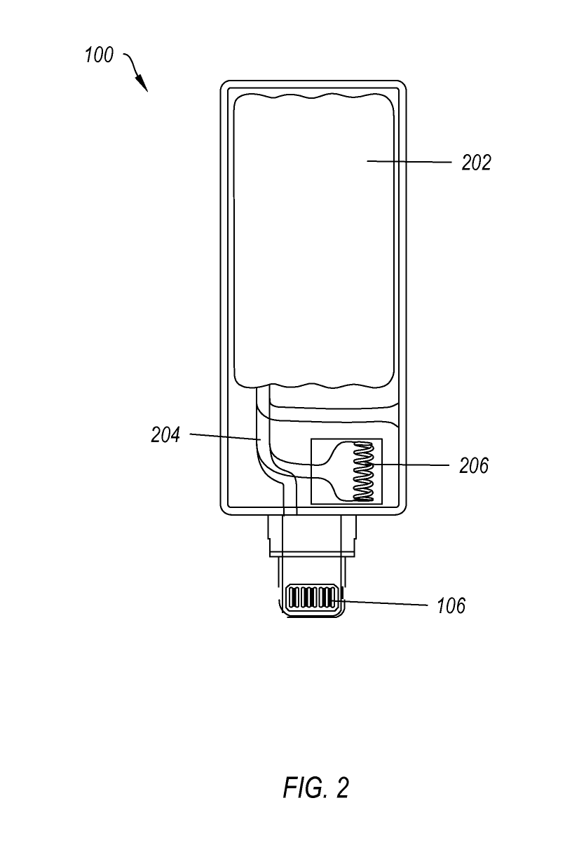

FIG. 2 illustrates an example of an internal view of the portable back-up battery pack 100. The portable back-up battery pack 100 minimizes unused internal space and weight to allow for increased portability. One of skill in the art will appreciate that since maximizing portability is a key goal that that the interior portable back-up battery pack 100 has little or no wasted internal space; however, FIG. 2 does not show all internal components to prevent confusion.

FIG. 2 shows that the portable back-up battery pack 100 can include a rechargeable battery 202 or other power source. A rechargeable battery 202 includes one or more electrochemical cells and its electrochemical reactions are electrically reversible. Several different combinations of chemicals can be used for the rechargeable battery 202, including: lead-acid, nickel cadmium (NiCd), nickel metal hydride (NiMH), lithium ion (Li-ion), and lithium ion polymer (Li-ion polymer). Keeping the rechargeable battery 202 as small as practical can allow be critical to allow for portability. For example, by using a rechargeable battery 202 which only partially charges the external electronic device the weight of the portable back-up battery pack 100 can be less than 16 grams.

FIG. 2 also shows that the portable back-up battery pack 100 can include an electrical connection 204. The electrical connection 204 allows power to flow from the rechargeable battery 202 to the electronic connector 106 and from the charging port to the rechargeable battery 202.

FIG. 2 further shows that the portable back-up battery pack 100 can include an inductive charger 206. Inductive charging (also known as “wireless charging”) uses an electromagnetic field to transfer energy between two objects. This is usually done with a charging station. Energy is sent through an inductive coupling to an electrical device, which can then use that energy to charge batteries or run the device. Induction chargers typically use an induction coil to create an alternating electromagnetic field from within a charging base station, and a second induction coil in the induction charger 206 takes power from the electromagnetic field and converts it back into electrical current to charge the rechargeable battery 202. The two induction coils in proximity combine to form an electrical transformer.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A portable back-up battery pack, the portable back-up battery pack comprising:
a housing;
a rechargeable battery pack within the housing;
an electronic connector, wherein the electronic connector:
extends from the housing; and
is configured to create an electrical connection between the rechargeable battery pack and an external electronic device; and
an attachment configured to connect the portable back-up battery pack to an external device.

2. The portable back-up battery pack of claim 1, wherein the housing is between 10 mm and 15 mm tall.

3. The portable back-up battery pack of claim 2, wherein the housing is approximately 12.5 mm tall.

4. The portable back-up battery pack of claim 1, wherein the housing is between 16 mm and 26 mm wide.

5. The portable back-up battery pack of claim 4, wherein the housing is approximately 21 mm wide.

6. The portable back-up battery pack of claim 1, wherein the housing is between 38.5 mm and 58.5 mm long.

7. The portable back-up battery pack of claim 6, wherein the housing is approximately 48.5 mm long.

8. The portable back-up battery pack of claim 1, further comprising an inductive charger.

9. A portable back-up battery pack, the portable back-up battery pack comprising:
a housing, wherein the housing is approximately rectangular;
a rechargeable battery pack within the housing;
a neck, wherein the neck includes a protrusion from the housing;
an electronic connector, wherein the electronic connector:
extends from the neck; and
is configured to create an electrical connection between the rechargeable battery pack and an external electronic device; and
an attachment configured to connect the portable back-up battery pack to an external device.

10. The portable back-up battery pack of claim 9, wherein the neck is between 3.5 mm and 5.5 mm tall.

11. The portable back-up battery pack of claim 10, wherein the neck is approximately 4.5 mm tall.

12. The portable back-up battery pack of claim 9, wherein the neck is between 7.8 mm and 11.8 mm wide.

13. The portable back-up battery pack of claim 12, wherein the neck is approximately 9.8 mm wide.

14. The portable back-up battery pack of claim 9, wherein the neck is between 4 mm and 6 mm long.

15. The portable back-up battery pack of claim 14, wherein the neck is approximately 5 mm long.

16. A portable back-up battery pack, the portable back-up battery pack comprising:
a housing, wherein the housing is approximately rectangular;
a rechargeable battery pack within the housing;
a neck, wherein the neck includes a protrusion from the housing;
an electronic connector, wherein the electronic connector:
extends from the neck; and
is configured to create an electrical connection between the rechargeable battery pack and an external electronic device;
a slider configured to extend and retract the electronic connector relative to the neck;
an attachment configured to connect the portable back-up battery pack to an external device;
a charging port, wherein the charging port:
is electrically connected to the rechargeable battery pack; and
is configured to allow a user to charge the rechargeable battery pack; and
a charge indicator configured to allow a user to determine the charge level of the rechargeable battery pack.

17. The portable back-up battery pack of claim 16, wherein the charging port is configured to receive a power cable.

18. The portable back-up battery pack of claim 16, wherein the attachment is configured to attach to a key ring.

19. The portable back-up battery pack of claim 16, wherein the charge indicator includes an LED.

20. The portable back-up battery pack of claim 16, wherein the weight of the battery pack is less than 16 grams.
